(19) United States
(12) Patent Application Publication
(10) Pub. No.: US 2026/0214152 A1
(43) Pub. Date: Jul. 23, 2026

(54) METHOD AND APPARATUS FOR PROCESSING CONTROL MESSAGE IN MOBILE COMMUNICATION SYSTEM

(71) Applicant: ELECTRONICS AND TELECOMMUNICATIONS RESEARCH INSTITUTE, Daejeon (KR)

(72) Inventors: Hyung Sub KIM, Daejeon (KR); Nam I KIM, Daejeon (KR); Tae Jung KIM, Sejong-si (KR); Jee Hyeon NA, Daejeon (KR); Dong Seok ROH, Daejeon (KR)

(21) Appl. No.: 19/423,725

(22) Filed: Dec. 17, 2025

(30) Foreign Application Priority Data
Jan. 21, 2025 (KR) 10-2025-0008683

(51) Int. Cl. H04L 69/322; H04L 47/24; H04W 36/00

(52) U.S. Cl. CPC H04L 69/322; H04L 47/24; H04W 36/0069

(57) ABSTRACT

The present disclosure provides a method and an apparatus for reflecting various QoS requirements or applying various logic in real time by adding a parameter to a control message when setting up a PDU session to determine which QoS flow to apply dual connectivity to. The present disclosure provides a method and an apparatus for adding a parameter (or indication information) in a QoS flow setup request list to prevent an MN from arbitrarily determining which QoS flow to apply dual connectivity to.

### CROSS-REFERENCE TO RELATED APPLICATION

This application claims the benefit of and priority to Korean Patent Application No. 10-2025-0008683, filed on Jan. 21, 2025, the entire contents of which are hereby incorporated herein by reference in its entirety.

### TECHNICAL FIELD

The present disclosure relates to a method and an apparatus for processing a control message in a mobile communication system.

### BACKGROUND

The following description merely provides background information related to the present embodiments and does not constitute the related art.

In a 5G mobile communication system, various control messages are exchanged between a base station and an access and mobility management function (AMF) in a 5G core (5GC) through a next generation application protocol (NGAP) interface. The NGAP includes several message types, including messages supporting protocol data unit (PDU) session management for transmitting and receiving user data between a terminal, a base station, and a user plane function (UPF) of the 5GC.

The 5G base station supports dual connectivity (DC). The DC is a function of processing user data by utilizing a secondary node (SN) for load distribution and performance improvement for the terminal connected to a master node (MN). The DC process is performed through an Xn application protocol (XnAP) message between the MN and the SN. Only the MN determines which quality of service (QoS) flow to apply the DC to, which is performed according to a predefined policy to implement the base station. As a result, there are limitations in reflecting various QoS requirements or applying various logic in real time. This may hinder flexibility and real-time adaptability to QoS.

### SUMMARY

The present disclosure provides a method and an apparatus for reflecting various QoS requirements or applying various logic in real time by adding a parameter to a control message when setting up a PDU session to determine which QoS flow to apply dual connectivity to.

The present disclosure provides a method and an apparatus for adding a parameter (or indication information) in a QoS flow setup request list to prevent an MN from arbitrarily determining which QoS flow to apply dual connectivity to.

The problems to be solved by the present invention are not limited to the above-mentioned problems, and other problems that are not mentioned will be clearly understood by those skilled in the art from the following description.

According to an embodiment of the present disclosure, a method for processing a control message in a mobile communication system includes the steps of: receiving, by a master node (MN), a protocol data unit (PDU) session resource setup request message for setting up a PDU session from an access and mobility management function (AMF); determining, by the MN, whether a specific quality of service (QoS) flow included in the PDU session is capable of dual connectivity and whether a subject communicating with a user plane function (UPF) is set to one of the MN and a secondary node (SN), based on indication information included in the PDU session resource setup request message; transmitting, by the MN, an SNode addition request message to the SN when the QoS flow is capable of dual connectivity and the subject communicating with the UPF is set to one of the MN and the SN; and receiving, by the MN, an SNode addition request acknowledgement message from the SN.

According to another embodiment of the present disclosure, an apparatus for processing a control message in a mobile communication system includes the MN configured to: receive a PDU session resource setup request message for setting up a PDU session from the AMF; determine whether a specific QoS flow included in the PDU session is capable of dual connectivity and whether a subject communicating with the UPF is set to one of the MN and the SN, based on indication information included in the PDU session resource setup request message; transmit an SNode addition request message to the SN when the QoS flow is capable of dual connectivity and the subject communicating with the UPF is set to one of the MN and the SN; and receive an SNode addition request acknowledgement message from the SN.

According to another embodiment of the present disclosure, a method for processing a control message in a mobile communication system includes the steps of: receiving, by the MN, an initial context setup request message for setting up a PDU session from the AMF; determining, by the MN, whether a specific QoS flow included in the PDU session is capable of dual connectivity and whether a subject communicating with the UPF is set to one of the MN and the SN, based on indication information included in the initial context setup request message; transmitting, by the MN, an SNode addition request message to the SN when the QoS flow is capable of dual connectivity and whether the subject communicating with the UPF is set to one of the MN and the SN; and receiving, by the MN, an SNode addition request acknowledgement message from the SN.

In the present disclosure, various QoS requirements may be reflected or various logic may be applied in real time by adding a parameter to a control message when setting up a PDU session to determine which QoS flow to apply dual connectivity to.

In the present disclosure, a parameter (or indication information) in a QoS flow setup request list may be added to prevent the MN from arbitrarily determining which QoS flow to apply dual connectivity to.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a conceptual diagram of a mobile communication system according to an embodiment of the present disclosure.

FIG. 2 is a diagram of a communication node according to an embodiment of the present disclosure.

FIG. 3 is a diagram illustrating reference points according to an embodiment of the present disclosure.

FIG. 4 is a flowchart of a session setup method according to an embodiment of the present disclosure.

FIG. 5 is a flowchart of a handover method from an MN to an SN according to an embodiment of the present disclosure.

FIG. 6 is a diagram illustrating a dual connectivity scenario according to an embodiment of the present disclosure.

FIG. 7 is a diagram illustrating a dual connectivity scenario according to another embodiment of the present disclosure.

FIG. 8 is a diagram illustrating a mobility connection scenario between an MN and an SN when the MN determines to set up a PDU session in the SN, according to another embodiment of the present disclosure.

FIG. 9 is an example diagram of a message related to an initial context setup applied to an embodiment of the present disclosure.

FIG. 10 is an example diagram of a message related to a PDU session resource setup according to an embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing components of embodiments of the present disclosure, reference numerals, such as first, second, i), ii), a), and b), may be used. These reference numerals are only used to distinguish the components from other components, and the nature, sequence, order, or the like of the components is not limited by the reference numerals. In the specification, when a part “includes” or “comprises” an element, unless explicitly stated otherwise, the part may further include other elements rather than excluding the other elements.

The detailed description set forth below in conjunction with the appended drawings is intended to describe exemplary embodiments of the disclosure and is not intended to represent the only embodiments in which the present disclosure can be practiced.

The MN herein is a network node functioning as a primary node in dual connectivity, mainly sets up an initial connection with user equipment (UE) and manages a control signal.

The SN is a network node functioning as an auxiliary node in dual connectivity and cooperates with the MN to provide additional resources to the UE or to support data transmission.

The MN corresponds to NG-RAN node 1 and the SN corresponds to NG-RAN node 2.

A communication network to which embodiments are applied will be described according to the present invention. The communication network may include a non-terrestrial network (NTN), a 4G communication network (e.g., a long-term evolution (LTE) communication network), a 5G communication network (e.g., a new radio (NR) communication network), or the like. In addition, as an example, the communication network, which is not is not limited to a specific form, may include a new type of communication network or a 6G communication network as a next-generation communication network. Throughout the specification, the network, which is not is not limited to a specific form, may include, e.g., wireless internet, such as wireless fidelity (WiFi), a portable internet, such as wireless broadband internet (WiBro) or world interoperability for microwave access (WiMax), a 2G mobile communication network, such as global system for mobile communication (GSM) or code division multiple access (CDMA), a 3G mobile communication network, such as wideband code division multiple access (WCDMA) or CDMA 2000, a 3.5G mobile communication network, such as high speed downlink packet access (HSDPA) or high speed uplink packet access (HSUPA), a 4G mobile communication network, such as long term evolution (LTE) network or LTE-advanced (LTE-A) network, a 5G mobile communication network, such as NR, and a 6G communication network or other networks, as next generation communication networks.

Throughout the specification, the UE may be referred to as a terminal, an access terminal, a mobile terminal, a station, a subscriber station, a mobile station, a portable subscriber station, a node, a device, or the like.

Examples of the UE for communication may include a desktop computer, a laptop computer, a tablet PC, a wireless phone, a mobile phone, a smartphone, a smartwatch, a smartglass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, and a digital video player.

Throughout the specification, a base station may be referred to as a Node B, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like.

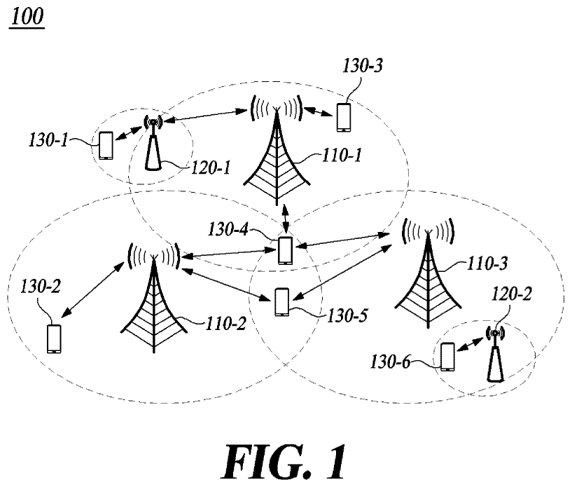

FIG. 1 is a conceptual diagram of a mobile communication system according to an embodiment of the present disclosure.

Referring to FIG. 1, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communication (e.g., LTE and LTE-A) defined in the third generation partnership project (3GPP) standard, 5G communication (e.g., NR), and next-generation communication (e.g., 6G). The 4G communication may be performed in a frequency band of 6 GHz or less, and the 5G communication may be performed in a frequency band of 6 GHz or less as well as a frequency band of 6 GHz or greater. In 6G communication, a THz frequency band may be used and artificial intelligence (AI) and other technologies may be applied. The communication system 100 is not limited to a specific form.

For example, for 4G communication, 5G communication, and 6G communication, a plurality of communication nodes may support a CDMA-based communication protocol, a WCDMA-based communication protocol, a time division multiple access (TDMA)-based communication protocol, a frequency division multiple access (FDMA)-based communication protocol, an orthogonal frequency division multiplexing (OFDM)-based communication protocol, a filtered OFDM-based communication protocol, a cyclic prefix (CP)-OFDM-based communication protocol, a discrete Fourier transform-spread-OFDM (DFT-s-OFDM)-based communication protocol, an orthogonal frequency division multiple access (OFDMA)-based communication protocol, a single carrier (SC)-FDMA-based communication protocol, a non-orthogonal multiple access (NOMA)-based communication protocol, a generalized frequency division multiplexing (GFDM)-based communication protocol, a filter bank multi-carrier (FBMC)-based communication protocol, a universal filtered multi-carrier (UFMC)-based communicational protocol, a space division multiple access (SDMA)-based communication protocol, and the like.

In addition, the communication system 100 may further include a core network. When the communication system 100 supports 4G communication, the core network may include a serving-gateway (S-GW), a packet data network (PDN)-gateway (P-GW), and a mobility management entity (MME). When the communication system 100 supports 5G communication, the core network may include a user plane function (UPF), a session management function (SMF), an access and mobility management function (AMF), and the like. In addition, as an example, when the communication system 100 supports 5G communication, the core network may be configured based on a function based on 5G communication or a new function and may not be limited to a specific form.

On the other hand, each of the plurality of communication nodes 110-1, 110-2, 110-3, 120-1, 120-2, 130-1, 130-2, 130-3, 130-4, 130-5, and 130-6 constituting the communication system 100 may have the following structure.

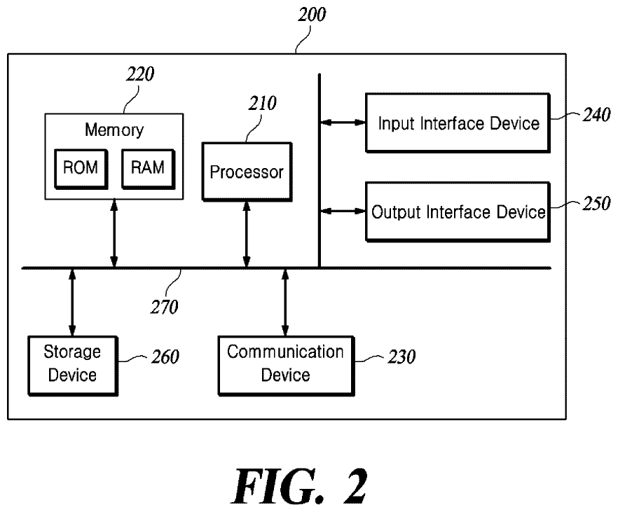

FIG. 2 is a diagram of a communication node according to an embodiment of the present disclosure.

Referring to FIG. 2, a communication node 200 (or a network function) may include at least one processor 210, memory 220, and a transceiver 230 connected to a network to perform communication. In addition, the communication node 200 may further include an input interface device 240, an output interface device 250, and a storage device 260. Components of the communication node 200 may be connected to each other by bus 270 to communicate with each other.

However, each of the components included in the communication node 200 may be connected through a separate interface or a separate bus around the processor 210, instead of the bus 270. For example, the processor 210 may be connected to at least one of the memory 220, the transceiver 230, the input interface device 240, the output interface device 250, and the storage device 260 through a dedicated interface.

The processor 210 may execute a program command stored in at least one of the memory 220 and the storage device 260. The processor 210 may refer to a central processing unit (CPU), a graphics processing unit (GPU), or a dedicated processor on which the methods according to embodiments of the present invention are performed. Each of the memory 220 and the storage device 260 may include at least one of a volatile storage medium and a nonvolatile storage medium. For example, the memory 220 may include at least one of read-only memory (ROM) and random-access memory (RAM).

Referring back to FIG. 1, the communication system 100 may include the plurality of base stations 110-1, 110-2, 110-3, 120-1, and 120-2 and the plurality of UEs 130-1, 130-2, 130-3, 130-4, 130-5, and 130-6. The communication system 100 including the base stations 110-1, 110-2, 110-3, 120-1, and 120-2 and the UEs 130-1, 130-2, 130-3, 130-4, 130-5, and 130-6 may be referred to as an “access network”. Each of the first base station 110-1, the second base station 110-2, and the third base station 110-3 may form a macro cell. Each of the fourth base station 120-1 and the fifth base station 120-2 may form a small cell. The fourth base station 120-1, the third UE 130-3, and the fourth UE 130-4 may belong to the cell coverage of the first base station 110-1. The second UE 130-2, the fourth UE 130-4, and the fifth UE 130-5 may belong to the cell coverage of the second base station 110-2. The fifth base station 120-2, the fourth UE 130-4, the fifth UE 130-5, and the sixth UE 130-6 may belong to the cell coverage of the third base station 110-3. The first UE 130-1 may belong to the cell coverage of the fourth base station 120-1. The sixth UE 130-6 may belong to the cell coverage of the fifth base station 120-2.

Each of the plurality of base stations 110-1, 110-2, 110-3, 120-1, and 120-2 may be referred to as a NodeB, an evolved NodeB, a gNB, an xNB, a base transceiver station (BTS), a radio base station, a radio transceiver, an access point, an access node, or the like. Each of the plurality of UEs 130-1, 130-2, 130-3, 130-4, 130-5, and 130-6 may be referred to UE, a terminal, an access terminal, a mobile terminal, a station, a subscriber station, a mobile station, a portable subscriber station, a node, a device, or the like.

Each of the plurality of base stations 110-1, 110-2, 110-3, 120-1, and 120-2 may operate in a different frequency band or in the same frequency band. The plurality of base stations 110-1, 110-2, 110-3, 120-1, and 120-2 may be connected to each other through an ideal backhaul link or a non-ideal backhaul link and may exchange information with each other through the ideal backhaul link and the non-ideal backhaul link. Each of the plurality of base stations 110-1, 110-2, 110-3, 120-1, and 120-2 may be connected with the core network through the ideal backhaul link or the non-ideal backhaul link. Each of the plurality of base stations 110-1, 110-2, 110-3, 120-1, and 120-2 may transmit a signal received from the core network to the corresponding UE 130-1, 130-2, 130-3, 130-4, 130-5, and 130-6 and may transmit a signal received from the corresponding UE 130-2, 130-4, and 130-5 to the core network.

In addition, as an example, the core network of the communication system is configured with an architecture based on interaction between network functions (NFs). As an example, a core network of a 5G system, such as 5GC, may include various entities. Specifically, the AMF may manage access and mobility of the UE. The AMF may perform non-access stratum (NAS) security management and mobility management functions for the UE in a rest state.

The SMF may manage a session. As an example, the SMF may allocate an internet protocol (IP) address and control a PDU session.

In addition, a policy control function (PCF) may control a policy. In addition, the PCF may include the UPF that controls a user plane. The UPF, which is a function of a gateway for transmitting and receiving data, may perform all or some of user plane functions of the S-GW and the P-GW of the previous mobile communication system (4G). In addition, the UPF may handle the PDU. In addition, the UPF may include an application function (AF) that controls application functions. The AF may be a function for providing a plurality of services to the UE. In addition, the AF may include a unified data management (UDM) for managing unified data. The UDM may manage subscriber information.

In addition, as an example, a core network of a next-generation system (e.g., 6G), which is not limited to a specific form, may have the same type of function as the function of the 5G system and may be referred to by the same name, or a new entity (or function) based on the next-generation system may be formed. However, in the next-generation system, functions for managing access and mobility of the UE or managing the session may be configured as described above, and the same may be applied to the following matters. Although the 5G system is described below as a reference for convenience of description, the present disclosure is not limited thereto and may be equally applied to the next-generation system.

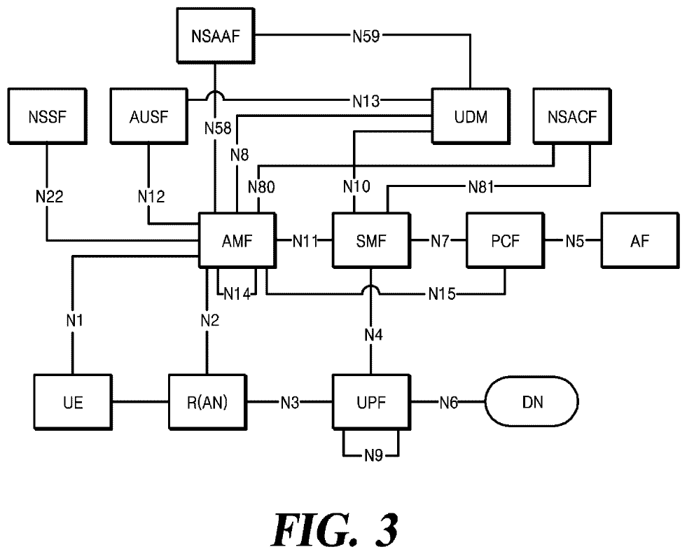

FIG. 3 is a diagram illustrating reference points according to an embodiment of the present disclosure.

Referring to FIG. 3, a reference point may indicate a mutual operation between NF services in NFs described by a point-to-point reference point between two NFs. For example, N1 may be a reference point between the UE and the AMF. N2 may be a reference point between the (R)AN and the AMF. N3 may be a reference point between the (R)AN and the UPF. Other reference points may be, but are not limited to, as shown in Table 1 below.

TABLE 1
N1: Reference point between the UE and the AMF.
N2: Reference point between the (R)AN and the AMF.
N3: Reference point between the (R)AN and the UPF.
N4: Reference point between the SMF and the UPF.
N5: Reference point between the PCF and an AF or TSN AF.
N6: Reference point between the UPF and a Data Network (DN).
N7: Reference point between the SMF and the PCF.
N8: Reference point between the UDM and the AMF.
N9: Reference point between two UPFs.
N10: Reference point between the UDM and the SMF.
N11: Reference point between the AMF and the SMF.
N12: Reference point between the AMF and an Authentication Sever
Function (AUSF).
N13: Reference point between the UDM and the AUSF.
N14: Reference point between two AMFs.
N15: Reference point between the PCF and the AMF in the case of non-
roaming scenario, PCF in the visited network and the AMF in the case
of roaming scenario.
N16: Reference point between two SMFs, (in roaming case between the
SMF in the visited network and the SMF in the home network).
N16a: Reference point between the SMF and I-SMF.
N17: Reference point between the AMF and 5G-EIR.
N18: Reference point between any NF and UDSF.
N19: Reference point between two PSA UPFs for 5G LAN-type service.
N22: Reference point between the AMF and NSSF.

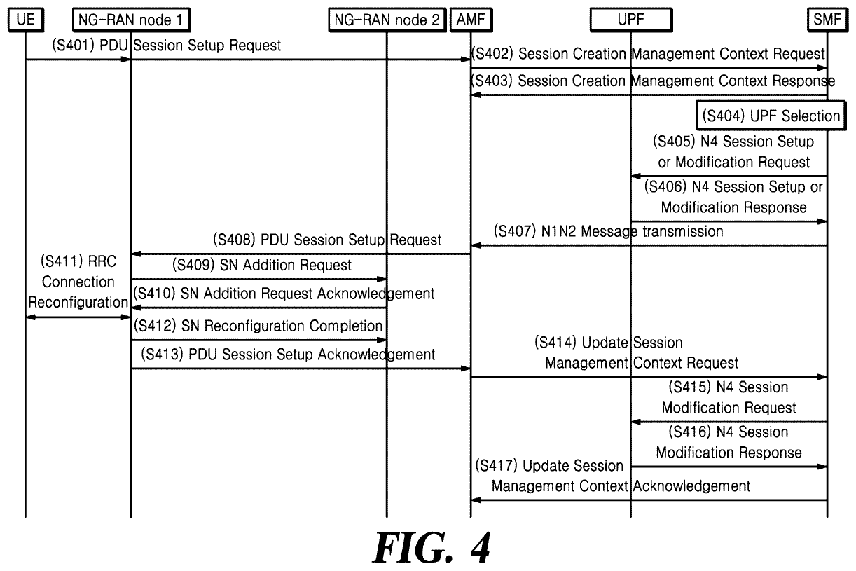

FIG. 4 is a flowchart of a session setup method according to embodiments of the present disclosure. In step 401, the UE may transmit a PDU session setup request message to the AMF. The UE may transmit the PDU session setup request message to the base station through a radio resource control (RRC) message. The base station may transmit the PDU session setup request message to the AMF through an NG access protocol (AP) message (NGAP message). The base station may be the NG-RAN node 1.

In step 402, the AMF may transmit a session creation management context request message to the SMF.

In step 403, the SMF may transmit a session creation management context response message to the AMF.

In step 404, the SMF selects the UPF. The method of selecting the UPF may use one of the methods described in Table 2 but is not limited thereto.

TABLE 2
The SMF selects a geographically close UPF based on the location
information of the UE.
The SMF selects the UPF according to the QoS policy to ensure the
quality of service.
The SMF selects the UPF according to the policy and contract defined by
a network provider.
The SMF monitors the current load status of each UPF and selects the
UPF with less load.
In the 5G network slicing, the SMF selects the UPF suitable for a network
slice according to indication of a network slice selection function (NSSF).
The SMF selects the UPF according to a specific data network (DN) to
which the UPF needs to connect.

In step 405, the SMF transmits an N4 session setup or modification request message to the selected UPF. If the request is an initial request, the SMF may start an N4 session setup procedure for the selected UPF. Otherwise, the SMF may start the N4 session modification procedure for the selected UPF. In step 406, the selected UPF transmits an N4 session setup response or an N4 session modification response message to the SMF.

In step 407, the SMF transmits an NIN2 message to the AMF. The message may include a PDU session ID, N2 session management information (N2 SM information), an N1 session container, and the like.

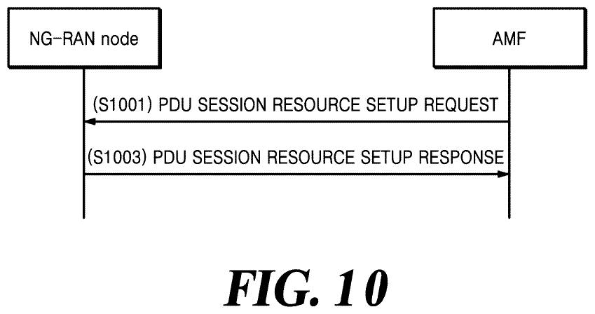

In step 408, the AMF transmits the PDU session setup request message to the NG-RAN node 1. The indication information included in the PDU session setup request message is the same as the indication information included in an initial context setup request message in FIG. 9 and a PDU session resource setup request message in FIG. 10 to be described later. Detailed descriptions of the indication information will be described with reference to FIG. 9, FIG. 10, and Table 3.

Based on the indication information (or the parameter) included in the PDU session setup request message, it is determined whether a specific QoS flow included in a PDU session is capable of dual connectivity and whether a subject communicating with the UPF is set to one of the NG-RAN node 1 and the NG-RAN node 2. If the QoS flow is capable of dual connectivity and the subject communicating with the UPF is set to one of the NG-RAN node 1 or the NG-RAN node 2, the NG-RAN node 1 performs step 409. The indication information included in the PDU session setup request message is described in Table 3 to be described later.

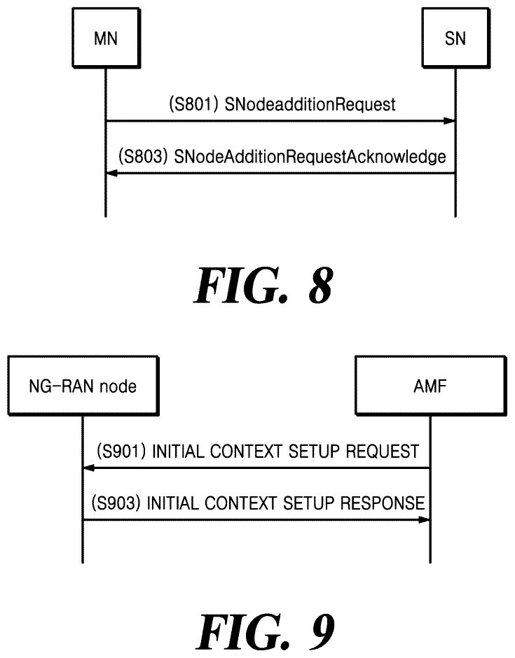

In step 409, the NG-RAN node 1 transmits an SNode addition request message to the NG-RAN node 2. The SNode addition request message includes the subject (NG-RAN node 1 or NG-RAN node 2) that communicates with the UPF. The SNode addition request message is the same as an SNode addition request message in FIG. 8 to be described later. Detailed descriptions thereof will be described with reference to FIG. 8.

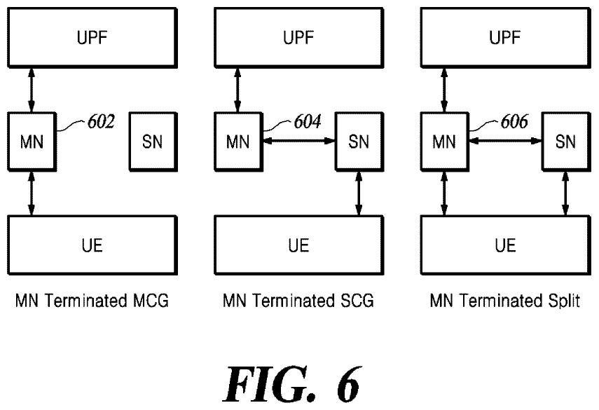

In step 410, the NG-RAN node 2 transmits an SNode addition request acknowledgement message to the NG-RAN node 1. The NG-RAN node 2 selects a cell group to be actually used and transmits the SNode addition request acknowledgement message including the selected cell group to the NG-RAN node 1. Upon receiving the SNode addition request acknowledgement message from the NG-RAN node 2, the NG-RAN node 1 performs dual connectivity as shown in FIG. 6.

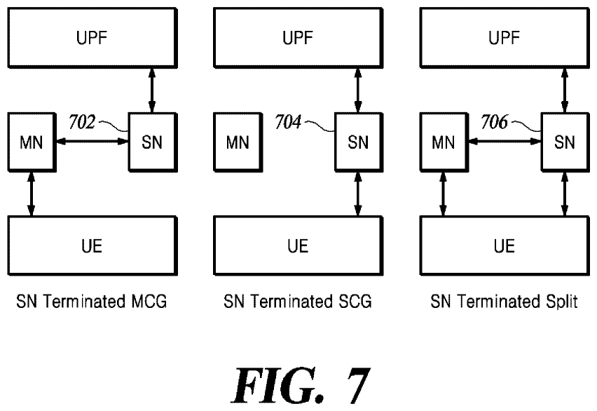

Additionally, when the subject communicating with the UPF is the NG-RAN node 2, after transmitting the SNode addition request acknowledgment message from the NG-RAN node 2 to the NG-RAN node 1, the NG-TRAN node 2 performs dual connectivity as shown in FIG. 7.

In step 411, the NG-RAN node 1 reconfigures the RRC connection with the UE. The NG-RAN node 1 may transmit a received NAS message to the UE. The UE may transmit an RRC connection reconfiguration completion message to the NG-RAN node 1.

Resources for the PDU session to be set up may be configured through this step.

In step 412, the NG-RAN node 1 transmits an SNode reconfiguration completion message to the NG-RAN node 2.

In step 413, the NG-RAN node 1 transmits a PDU session setup acknowledgement message to the AMF.

In step 414, the AMF transmits an update session management context request message to the SMF. The AMF may transmit, to the SMF, an identifier of the MN and/or the SN received from the NG-RAN node 1 or an identifier of the cell of the MN accessed by the UE and/or the SN access by the UE. In addition, the AMF may transmit the session management information received from the NG-RAN to the SMF.

In step 415, the SMF transmits an N4 session modification request message to the selected UPF.

In step 416, the selected UPF transmits an N4 session modification response message to the SMF.

In step 417, the SMF transmits an update session management context acknowledgement message to the AMF.

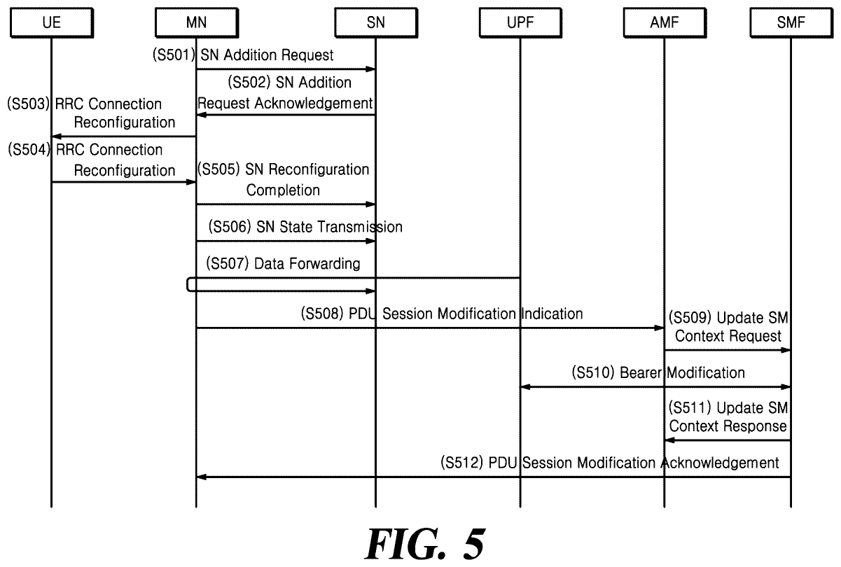

FIG. 5 is a flowchart of a handover method from the MN to the SN according to an embodiment of the present disclosure.

The MN corresponds to the NG-RAN node 1 in FIG. 4 and the SN corresponds to the NG-RAN node 2 in FIG. 4.

The MN receives the PDU session setup request message, and determines, based on the indication information included in the PDU session setup request message, whether a specific QoS flow included in the PDU session is capable of dual connectivity and a subject communicating with the UPF is set to one of the MN and the SN. If the QoS flow is capable of dual connectivity and the subject communicating with the UPF is set to the one of the MN and the SN, the MN performs step 501.

In step 501, the MN transmits an SNode addition request message to the SN. The SNode addition request message includes the subject (MN or SN) that communicates with the UPF. The SNode addition request message is the same as an SNode addition request message in FIG. 8 to be described later. Detailed descriptions thereof will be described with reference to FIG. 8.

In step 502, the SN transmits a SNode addition request acknowledgement message to the MN. The SN selects a cell group to be actually used and transmits the SNode addition request acknowledgement message including the selected cell group to the MN. Upon receiving the SNode addition request acknowledgement message from the SN, the MN performs dual connectivity as shown in FIG. 6.

In addition, when the subject communicating with the UPF is the SN, after transmitting the SNode addition request acknowledgment message from the SN to the MN, the SN performs dual connectivity as shown in FIG. 7.

In step 503, the MN transmits an RRC connection reconfiguration message to the UE.

In step 504, the UE transmits an RRC connection reconfiguration completion message to the MN.

In step 505, the MN transmits an SN reconfiguration completion message to the SN.

In step 506, the MN may transmit a sequence number (SN) state transition message to the SN for a bearer terminated by the SN using a radio link control (RLC) acknowledgement mode (AM).

In step 507, for the bearer terminated by the SN using the RLC AM, the MN starts a data forwarding procedure according to a bearer characteristic of the corresponding QoS flow.

The QoS flow refers to a logical data flow configured to ensure data transmission quality in the 5G system and refers to a data packet flow satisfying a specific QoS requirement in a specific PDU session. The QoS flow is a concept of managing a network to meet data transmission requirements (e.g., bandwidth, latency, and priority) required by various services. Each QoS flow is managed with a unique identifier, such as a QoS flow identifier (QFI). For example, bandwidth-centric data, such as video streaming, and low-latency-centric data, such voice over IP (VOIP), are managed with different QoS flows.

In step 508, for the bearer terminated by the SN, the MN transmits a PDU session modification indication message to the AMF. The message may include an identifier of the SN or an identifier of the cell of the SN accessed by the UE. The identifier of the SN or the identifier of the cell of the SN accessed by the UE may be included in PDU session modification indication transfer information.

In step 509, the AMF may transmit an update session management context request message to the SMF. The AMF may transmit, to the SMF, the identifier of the SN accessed by the UE received from the MN or the identifier of the cell of the SN.

In step 510, the SMF transmits an N4 session modification request message to the UPF.

In step 511, the SMF may transmit an update session management context acknowledgement message to the AMF.

In step 512, the SMF may transmit a PDU session modification acknowledgement message to the MN.

FIG. 6 is a diagram illustrating a dual connectivity scenario according to an embodiment of the present disclosure.

FIG. 7 is a diagram illustrating a dual connectivity scenario according to another embodiment of the present disclosure.

The flow of data after dual connectivity setup in FIG. 6 and FIG. 7 is the same. For example, a term in the form of “X Terminated Y” is used. The MN or SN is used for X (or X Terminated), and the MCG, SCG, or SPLIT is used for Y. In other words, X (or X Terminated) represents a subject that performs a function of transmitting and receiving data to and from the UPF and Y represents a cell group to be actually used.

The MCG refers to a cell group in which the MN is responsible for setting up initial connection with the UE and transmitting the control signal in dual connectivity.

The SCG refers to a cell group in which the SN is responsible for transmitting data in dual connectivity.

The SPLIT refers to a cell group in which the MCG and the SCG are simultaneously selected in dual connectivity.

FIG. 6 illustrates a dual connectivity scenario according to an embodiment of the present disclosure.

FIG. 6 illustrates a dual connectivity scenario, where X is MN 602, 604, or 606 and Y is MCG, SCG, or SPLIT, with specific conditions and corresponding selections.

For example, when X is the MN 602, the SN selects Y (MCG). In this case, the MN operates in a manner to process data or maintain connectivity through the MCG.

When X is the MN 604, the SN selects Y (SCG). In this case, the MN operates in a manner to process data or maintain connectivity through the SCG.

When X is the MN 606, the SN selects Y (SPLIT). In this case, the MN operates in a manner to transmit data or maintain connectivity by using the MCG and the SCG simultaneously.

FIG. 7 illustrates a dual connectivity scenario according to another embodiment of the present disclosure.

FIG. 7 illustrates a dual connectivity scenario where X is SN 702, 704, or 706 and Y is MCG, SCG, or SPLIT, with specific conditions and corresponding selections.

For example, when X is the SN 702, the SN selects Y (MCG). In this case, the SN operates in a manner to process data or maintain connectivity through the MCG.

When X is the SN 704, the SN selects Y (SCG). In this case, the SN operates in a manner to process data or maintain connectivity through the SCG.

When X is the SN 706, the SN selects Y (SPLIT). In this case, the SN operates in a manner to transmit data or maintain connectivity using the MCG and the SCG simultaneously.

FIG. 8 is a diagram illustrating a mobility connection scenario between the MN and the SN when the MN determines to set up a PDU session in the SN, according to another embodiment of the present disclosure.

In dual connectivity, in step 801, the MN transmits the SNode addition request message including the subject (the MN or the SN) communicating with the UPF to the SN.

In step 803, the SN receiving the SNode addition request message selects Y (MCG, SCG, or SPLIT) and transmits the SNode addition request acknowledgement message including the selection result to the MN.

FIGS. 6, 7, and 8 show operations during the dual connectivity. On the other hand, FIGS. 9 and 10 show the operations before the dual connectivity.

The dual connectivity may be set to multiple QoS flow levels included in the PDU session. For example, it is assumed that PDU sessions 1 and 2 are configured in a specific UE, QoS flows 1, 2, and 3 are configured in PDU session 1, and QoS flows 4, 5, and 6 are configured in PDU session 2.

If dual connectivity is applied only to QoS flows 4 and 6 of PDU session 2, the logic may be developed. Conventionally, only the MN determines which QoS flow to apply dual connectivity to. In this case, to implement the base station, it is necessary to operate according to a predefined policy, making it difficult to reflect various QoS requirements or develop various logic in real time.

Therefore, in an embodiment of the present disclosure, in the process of setting up the PDU session from the AMF, whether dual connectivity is applicable to QoS flow included in a specific PDU session, and if possible, which scenario of MN Terminated or SN Terminated is preferred, and the like will be described with reference to FIG. 9, FIG. 10, and Table 3.

FIG. 9 is an example diagram of a message related to an initial context setup applied to an embodiment of the present disclosure.

In step 901, the NG-RAN node transmits an initial context setup request message to the AMF. The initial context setup request message includes a PDU session resource setup request list IE. It is stated in 8.3.1.2 in the 3GPP standard TS38.413 that “when the PDU session resource setup request list IE is included in the initial context setup request message, the NG-RAN node operates in the same manner as defined in the PDU session resource setup procedure. The NG-RAN node must report the setup result of each requested PDU session resource to the AMF through the initial context setup response message as defined in the PDU session resource setup procedure.” In step 903, the AMF transmits an initial context setup response message to the NG-RAN node.

FIG. 10 is an example diagram of a message related to a PDU session resource setup according to an embodiment of the present disclosure.

In step 1001, the AMF transmits a PDU session resource setup request message to the NG-RAN node. The PDU session resource setup request includes the PDU session resource setup request list IE. It is stated in 8.2.1.2 in the 3GPP standard TS38.413 that “the PDU session resource setup request message must include the necessary information for the NG-RAN node to set up the NG-RAN configuration related to the PDU session, which configuration shall consist of at least one or more PDU session resources. In addition, each PDU session resource to be configured must be included in the PDU session resource setup request list IE”. In step 1003, the NG-RAN node transmits a PDU session resource setup response message to the AMF.

The PDU session setup is performed through the initial context setup request message in FIG. 9 or the PDU session resource setup request message in FIGS. 10A and 10B in the NGAP message.

The PDU session-specific detail information included in the initial context setup request message in FIG. 9 or the PDU session resource setup request message in FIGS. 10A and 10B is defined in 9.3.4.1 PDU session resource setup request transfer in the 3GPP standard TS38.413. In an embodiment of the present disclosure, the parameters (MR-DC Support and Termination) shown in Table 3 are added to the QoS flow setup request list included in the PDU session resource setup request transfer.

TABLE 3

| IE/Group | | | IE type and | Semantics | | Assigned |
|---|---|---|---|---|---|---|
| Name | Presence | Range | Reference | description | Criticality | Criticality |
| QoS Flow | | 1 | | | YES | reject |
| Setup | | | | | | |
| Request | | | | | | |
| List | | | | | | |
| >QoS | | 1..<maxnoofQoSFlows> | | | | |
| Flow Setup | | | | | | |
| Request | | | | | | |
| Item | | | | | | |
| >>QoS | M | | 9.3.1.51 | | | |
| Flow | | | | | | |
| Identifier | | | | | | |
| >>MR- | O | | | | | |
| DC | | | | | | |
| Support | | | | | | |
| >>>Termination | O | | ENUMERATED | | YES | ignore |
| | | | (MN, SN) | | | |

In the process of setting up the PDU session from the AMF, if MR-DC support is set for the QoS flow included in a specific PDU session and termination is set to the MN, dual connectivity of the MN Terminated scenario is performed, as shown in FIG. 6.

On the other hand, in the process of setting up the PDU session from the AMF, if termination is set to the SN for the QoS flow included in a specific PDU session, dual connectivity of the SN Terminated scenario is performed, as shown in FIG. 7.

In addition, when the MR-DC support is set up but termination is omitted, the MN arbitrarily determines the subject communicating with the UPF as the MN or the SN.

On the other hand, an aggregated maximum bit rate (AMBR) defined in the 3GPP refers to a maximum performance (i.e., data rate) that the base station can support in the NGAP. The AMBR is separately defined for each UE unit and each PDU session unit.

The PDU session AMBR and the UE AMBR that are independently defined do not necessarily have any mathematical correlation, but the sum of the AMBR of the PDU session set up in a specific UE is directly/indirectly related to the UE AMBR.

Therefore, the initial context setup request and the PDU session resource setup request messages, which are messages for actually setting up the PDU session, are designed in the standard so that the PDU session AMBR and the UE AMBR can be set up simultaneously. However, only the PDU session AMBR exists in the PDU session resource modify request and PDU session resource command messages used to modify and release the PDU session, and the UE AMBR is not defined.

In the current standard, if the UE AMBR needs to be modified in the process of modifying or releasing the PDU session, there is a disadvantage that the UE context modification procedure needs to be additionally performed. Therefore, in another embodiment of the present disclosure, as shown in Table 4 below, the UE AMBR is added in the PDU session resource release command message and the PDU session resource modify request message.

TABLE 4

| UE | O | 9.3.1.58 | YES | ignore |
|---|---|---|---|---|
| Aggregate | | | | |
| Maximum Bit Rate | | | | |
| | | | IE type and | Semantics |
| IE/Group Name | Presence | Range | reference | description |
| UE Aggregate | | 1 | | Applicable for Non- |
| Maximum Bit | | | | GBR QoS flows. |
| Rate | | | | |
| >UE Aggregate | M | | Bit Rate | This IE indicates the |
| Maximum Bit Rate | | | 9.3.1.4 | UE Aggregate |
| Downlink | | | | Maximum Bit Rate as |
| | | | | specified in TS |
| | | | | 23.501 [9] in the |
| | | | | downlink direction. |
| >UE Aggregate | M | | Bit Rate | This IE indicates the |
| Maximum Bit Rate | | | 9.3.1.4 | UE Aggregate |
| Uplink | | | | Maximum Bit Rate as |
| | | | | specified in TS |
| | | | | 23.501 [9] in the |
| | | | | uplink direction. |

Previously, a separate UE context modification procedure had to be further performed to modify the UE AMBR. In another embodiment of the present disclosure, this can be made unnecessary so that all information can be processed in a single procedure in the PDU session modification or release process. As a result, the signal processing overheads of the network are reduced and the procedure execution time is shortened.

In addition, since the UE AMBR modification is made in the PDU session management message, network resource allocation and coordination can be made more efficiently. Therefore, in another embodiment of the present disclosure, the utilization rate of network resources is optimized and the latency due to excessive signal processing is also reduced.

In addition, when the UE AMBR field is added to the PDU session resource release command and modify request messages, the 5G network standard may be more flexible and meet requirements in various scenarios. In particular, performance degradation in situations such as increased complexity of a network environment or high-speed mobility can be avoided.

Additionally, the UE AMBR plays a key role in limiting the maximum bandwidth that the UE can use. By making this immediately modifiable, QoS management becomes more sophisticated.

In addition, conventionally, PDU session modification and UE AMBR modification are separately performed, thereby causing synchronization. However, in another embodiment of the present disclosure, these are managed and integrated, thereby preventing data transmission interruption or setting conflicts and improving network stability.

At least some components described in the exemplary embodiments of the present disclosure may be implemented as hardware elements including at least one or a combination of a digital signal processor (DSP), a processor, a controller, an application-specific IC (ASIC), a programmable logic device (e.g., FPGA), and other electronic devices. In addition, at least some functions or processes described in the exemplary embodiments may be implemented in software, wherein the software may be stored in a recording medium. At least some components, functions, and processes described in the exemplary embodiments of the present disclosure may be implemented in a combination of hardware and software.

The method according to the exemplary embodiments of the present disclosure may be written as a computer-executable program and may also be implemented in various recording media, such as a magnetic storage medium, an optical reading medium, and a digital storage medium.

Implementations of the various techniques described herein may be made in digital electronic circuitry, or in computer hardware, firmware, software, or in combinations thereof. The implementations may be made as a computer program product, i.e., a computer program tangibly embodied in an information carrier, e.g., a machine-readable storage device (computer-readable medium) or a propagated signal, for processing by or controlling the operation of a data processing device, e.g., a programmable processor, a computer, or multiple computers. A computer program, such as the computer program(s) described above, can be written in any form of programming language, including compiled or interpreted languages, and can be developed in any form, as a stand-alone program or as a module, a component, a subroutine, or other units suitable for use in a computing environment. The computer program can be developed for processing on one computer or multiple computers at one site or distributed across multiple sites and interconnected by a communication network.

Processors suitable for processing the computer program include both general and special purpose microprocessors, and any one or more processors of any kind of digital computer. Generally, a processor will receive commands and data from ROM, RAM, or both. Elements of a computer may include at least one processor for executing commands and one or more memory devices for storing commands and data. Generally, a computer may include or may be coupled to one or more mass storage devices, such as magnetic, magneto-optical disks, or optical disks, that store data, to exchange data therebetween. Information carriers suitable for embodying computer program commands and data include, e.g., semiconductor memory devices, magnetic media, such as hard disks, floppy disks, and magnetic tape, optical media, such as compact disk read-only memory (CD-ROM), digital video disks (DVD), magneto-optical media, such as floptical disks, ROM, RAM, flash memory, erasable programmable ROM (EPROM), electrically erasable programmable ROM (EEPROM), and the like. The processor and the memory may be supplemented by, or incorporated in, special purpose logic circuitry.

The processor may execute an operating system and a software application executed on the operating system. In addition, the processor device may access, store, manipulate, process, and generate data in response to execution of the software. For ease of understanding, it may be described that one processor device is used, but a person skilled in the art may know that the processor device may include a plurality of processing elements and/or a plurality of types of processing elements. For example, the processor device may include a plurality of processors or one processor and one controller. Other processing configurations, such as parallel processors, are also possible.

Moreover, non-transitory computer-readable media may be any available media that can be accessed by a computer and include both computer storage media and transmission media.

While this specification contains many specific implementation details, these should not be construed as limitations on the scope of any invention or claims, but rather as descriptions of features that can be specific to particular embodiments of particular inventions. Certain features described herein in the context of individual embodiments may also be implemented in combination in a single embodiment. Conversely, various features described in the context of the single embodiment may also be implemented in multiple embodiments separately or in any suitable sub-combination. Moreover, although features are described as operating in certain combinations and initially claimed as such, one or more features from a claimed combination can in some cases be excluded from the combination, and the claimed combination may be modified into a sub-combination or the variation of a sub-combination.

Similarly, while operations are depicted in the drawings in a particular order, this should not be understood as requiring that such operations be performed in the particular order shown or in sequential order or that all illustrated operations be performed, to achieve desirable results. In certain cases, multitasking and parallel processing may be advantageous. Moreover, the separation of various device components in the embodiments described above should not be understood as requiring such separation in all embodiments, and it should be understood that the described program components and devices can generally be integrated together into a single software product or packaged into multiple software products.

It should be noted that the embodiments of the present disclosure disclosed herein and the drawings are merely specific examples for aiding understanding and are not intended to limit the scope of the present disclosure. It is obvious to a person skilled in the art that other variations based on the technical idea of the present invention can be implemented in addition to the embodiments disclosed herein.

The protection scope of the present embodiment should be construed according to the following claims, and all technical ideas within the scope equivalent thereto are construed as being included in the scope of rights of the present embodiment.

What is claimed is:

1. A method for processing a control signal in a mobile communication system, the method comprising:
receiving, by a master node (MN), a protocol data unit (PDU) session resource setup request message for setting up a PDU session from an access and mobility management function (AMF);
determining, by the MN, whether a specific quality of service (QoS) flow included in the PDU session is capable of dual connectivity and a subject communicating with a user plane function (UPF) is set to one of the MN and a secondary node (SN) based on indication information included in the PDU session resource setup request message;
transmitting, by the MN, an SNode addition request message to the SN when the QoS flow is capable of the dual connectivity and the subject communicating with the UPF is set to one of the MN and the SN; and
receiving, by the MN, an SNode addition request acknowledgment message from the SN.

2. The method of claim 1, wherein the SNode addition request message comprises a subject communicating with the UPF, and the SNode addition request acknowledgement message comprises a cell group selected by the SN.

3. The method of claim 1, further comprising arbitrarily determining, by the MN, the subject communicating with the UPF to be the MN or the SN when the QoS flow is capable of the dual connectivity and the subject communicating with the UPF is not set to one of the MN and the SN.

4. The method of claim 2, wherein the receiving, by the MN, the SNode addition request acknowledgment message from the SN comprises performing, by the subject communicating with the UPF, dual connectivity to the cell group selected by the SN.

5. The method of claim 4, wherein the cell group comprises at least one of a master cell group (MCG), a secondary cell group (SCG), and a SPLIT,
the MCG represents a cell group in which the MN is responsible for data transmission in the dual connectivity,
the SCG represents a cell group in which the SN is responsible for data transmission in the dual connectivity, and
the SPLIT represents a cell group in which the MCG and the SCG are simultaneously selected in the dual connectivity.

6. The method of claim 1, wherein the PDU session is set to a plurality of QoS flows.

7. An apparatus for processing a control message in a mobile communication system, the apparatus comprising a master node (MN) configured to:
receive a protocol data unit (PDU) session resource setup request message for setting up a PDU session from an access and mobility management function (AMF);
determine, based on indication information included in the PDU session resource setup request message, whether a subject communicating with a user plane function (UPF) is set to one of the MN and a secondary node (SN) and a specific quality of service (QoS) flow included in the PDU session is capable of dual connectivity;
transmit an SNode addition request message to the SN when the subject communicating with the UPF is set to one of the MN and the SN; and
receive an SNode add request acknowledgement message from the SN.

8. The apparatus of claim 7, wherein the SNode addition request message comprises the subject communicating with the UPF, and
the SNode addition request acknowledgement message comprises a cell group selected by the SN.

9. The apparatus of claim 7, wherein, when the QoS flow is capable of the dual connectivity and the subject communicating with the UPF is not set to one of the MN and the SN, the MN arbitrarily determines the subject communicating with the UPF to be the MN or the SN.

10. The apparatus of claim 8, wherein the receiving, by the MN, the SNode addition request acknowledgment message from the SN comprises performing, by the subject communicating with the UPF, dual connectivity to the cell group selected by the SN.

11. The apparatus of claim 10, wherein the cell group comprises at least one of a master cell group (MCG), a secondary cell group (SCG), and a SPLIT,
the MCG represents a cell group in which the MN is responsible for data transmission in the dual connectivity,
the SCG represents a cell group in which the SN is responsible for data transmission in the dual connectivity, and
the SPLIT represents a cell group in which the MCG and the SCG are simultaneously selected in the dual connectivity.

12. The apparatus of claim 7, wherein the PDU session is set to a plurality of QoS flows.

13. A method for processing a control message in a mobile communication system, the method comprising:
receiving, by a master node (MN), an initial context setup request message for setting up a protocol data unit (PDU) session from an access and mobility management function (AMF);
determining, by the MN, whether a specific quality of service (QoS) flow included in the PDU session is capable of dual connectivity and a subject communicating with a user plane function (UPF) is set to one of the MN and a secondary node (SN) based on indication information included in the initial context setup request message;
transmitting, by the MN, an SNode addition request message to the SN when the QoS flow is capable of the dual connectivity and the subject communicating with the UPF is set to one of the MN and the SN; and
receiving, by the MN, an SNode addition request acknowledgement message from the SN.

14. The method of claim 13, wherein the SNode addition request message comprises the subject communicating with the UPF, and the SNode addition request acknowledgment message comprises a cell group selected by the SN.

15. The method of claim 13, further comprising arbitrarily determining, by the MN, the subject communicating with the UPF to be the MN or the SN when the QoS flow is capable of the dual connectivity and the subject communicating with the UPF is not set to one of the MN and the SN.

16. The method of claim 14, wherein the receiving, by the MN, the SNode addition request acknowledgment message from the SN comprises performing, by the subject communicating with the UPF, dual connectivity to the cell group selected by the SN.

17. The method of claim 16, wherein the cell group comprises at least one of a master cell group (MCG), a secondary cell group (SCG), and a SPLIT,
the MCG represents a cell group in which the MN is responsible for data transmission in the dual connectivity,
the SCG represents a cell group in which the SN is responsible for data transmission in the dual connectivity, and
the SPLIT represents a cell group in which the MCG and the SCG are simultaneously selected in the dual connectivity.

18. The method of claim 13, wherein the PDU session is set to a plurality of QoS flows.
